(19) United States
(12) Patent Application Publication
(10) Pub. No.: US 2023/0415697 A1
(43) Pub. Date: Dec. 28, 2023

(54) SYSTEMS AND METHODS FOR DETECTION OF A SEATBELT GAMING ACTIVITY

(71) Applicant: GM GLOBAL TECHNOLOGY OPERATIONS LLC, Detroit, MI (US)

(72) Inventors: Alaa M. Khamis, Courtice (CA); Drew Walker, Whitby (CA); Jarvis Chau, Markham (CA)

(73) Assignee: GM GLOBAL TECHNOLOGY OPERATIONS LLC, Detroit, MI (US)

(21) Appl. No.: 17/809,231

(22) Filed: Jun. 27, 2022

(51) Int. Cl. B60R 22/48; G07C 5/00; G07C 5/10

(52) U.S. Cl. CPC B60R 22/48; G07C 5/008; G07C 5/10; B60R 2022/4866; B60R 2022/4883; B60R 2022/4841; B60R 2022/4816

(57) ABSTRACT

Systems and methods are provided for monitoring seatbelt usage by an occupant of a vehicle. The method includes, by a processor: receiving sensor data generated by at least one sensing device of the vehicle, determining a seatbelt gaming activity has occurred based on the sensor data, wherein the seatbelt gaming activity occurs when a seatbelt of the vehicle is latched while the occupant is not secured to a corresponding seat with the seatbelt, performing a persistence check to compare a frequency of the seatbelt gaming activity over a period of time to a minimum seatbelt gaming activity threshold, determining a classification of seatbelt gaming activity attributed to the occupant based on the persistence check, and generating record data that includes the classification of seatbelt gaming activity attributed to the occupant.

### INTRODUCTION

The technical field generally relates to vehicle seatbelt usage, and more particularly relates to systems and methods capable of detecting certain seatbelt gaming activities performed by an occupant of a vehicle including determining whether a seatbelt gaming activity has occurred in which the occupant attempted to circumvent a vehicle system associated with encouraging or requiring use of a seatbelt.

Most modern passenger vehicles include a seatbelt notification system intended to encourage drivers and other occupants to use seatbelts during operation of the vehicles. These notification systems are configured to alert a driver if a driver's seatbelt is not latched (i.e., unbuckled) upon ignition of an engine of the vehicle. Typically, the alerts include an intermittently flashing seatbelt reminder light and a repeating audible chime. The alerts may continue for a predetermined duration while the seatbelt remains unlatched or may continue indefinitely until the user fastens (i.e., latches/buckles) the seatbelt or turns off the engine.

Certain vehicles, such as certain fleet vehicles, may include a seatbelt requirement system that is intended to prevent operation of the vehicle while the driver's seatbelt is not latched. For example, some seatbelt requirement systems prevent ignition of the engine of the vehicle while the driver's seatbelt is not latched. Other seatbelt requirement systems prevent the driver from shifting from park while the driver's seatbelt is not latched.

For certain types of businesses that use fleet vehicles, such as last-mile delivery businesses, drivers of the fleet vehicles are often required to make frequent stops and may operate under strict schedules and timelines. In situations such as these, some drivers may attempt to game the seatbelt notification system and/or seatbelt requirement system of the fleet vehicles during operation thereof such that the drivers do not have to wear a seatbelt. Such activities may include, for example, latching the seatbelt with a strap thereof positioned behind the driver, tampering with the seatbelt or the seatbelt receiver (i.e., buckle assembly), and/or inserting a device into the seatbelt receiver other than the seatbelt latch (i.e., tongue plate).

Seatbelt gaming activities such as those described above may increase a likelihood of injury to the driver in the event of a collision and/or expose the owner of the fleet vehicle to liability. As such, some owners of fleet vehicles may desire to detect and/or reduce the occurrence of seatbelt gaming activities.

Accordingly, it is desirable to have systems and methods capable of detecting and/or discouraging seatbelt gaming activities. Furthermore, other desirable features and characteristics of the present invention will become apparent from the subsequent detailed description and the appended claims, taken in conjunction with the accompanying drawings and the foregoing technical field and background.

### SUMMARY

A method is provided for detection of a seatbelt gaming activity performed by an occupant of a vehicle. The vehicle has a seat for supporting the occupant thereon and a seatbelt configured to secure the occupant to the seat. The method includes, by a processor: receiving sensor data generated by at least one sensing device of the vehicle, determining the seatbelt gaming activity has occurred based on the sensor data, wherein the seatbelt gaming activity occurs when the seatbelt of the vehicle is latched while the occupant is not secured to the seat with the seatbelt, performing a persistence check to compare a frequency of the seatbelt gaming activity over a period of time to a minimum seatbelt gaming activity threshold, determining a classification of seatbelt gaming activity attributed to the occupant based on the persistence check, and generating record data that includes the classification of seatbelt gaming activity attributed to the occupant.

In various embodiments, the sensor data includes activation data generated by a digital key sensing device, and determining the seatbelt gaming activity has occurred is based on a determination that a digital key remotely started the vehicle and/or remotely locked a door of the vehicle while the seatbelt was latched.

In various embodiments, the sensor data includes position data generated by a range selection device status sensing device configured to sense a status of a range selection device (e.g., gear selector, gear shifter, PRNDL, etc.) configured to select a range (e.g., gear ratio) of a transmission of the vehicle, and determining the seatbelt gaming activity has occurred is based on a determination that the vehicle was shifted into park while the seatbelt was latched and the seatbelt remained latched for a time period in excess of a parking threshold and/or an idling threshold.

In various embodiments, the sensor data includes door data generated by a door status sensing device, and determining the seatbelt gaming activity has occurred is based on a determination that a door of the vehicle was opened, closed, and/or locked while the seatbelt was latched and the seatbelt remained latched for a period of time in excess of a door wait threshold or a lock wait threshold.

In various embodiments, the sensor data includes occupancy data generated by a seat occupancy sensing device or a driver monitor system, and determining the seatbelt gaming activity has occurred is based on a determination that the seat was unoccupied while the seatbelt was latched and the seatbelt remained latched for a period of time in excess of an occupancy threshold.

In various embodiments, the sensor data includes occupancy data generated by seat occupancy sensing device or a driver monitor system and seatbelt strap data generated by a seatbelt pretensioner sensing device and/or a seatbelt limiter device, and determining the seatbelt gaming activity has occurred is based on the seat being occupied while the seatbelt was latched and the strap of the seatbelt was not stretched.

In various embodiments, performing the persistence check includes comparing the frequency of the seatbelt gaming activity to a low gaming threshold and a high gaming threshold, wherein determining a classification of the seat belt gaming activity includes a first classification of no seatbelt gaming activity in which the frequency of the gaming activity is less than the low gaming threshold, a classification of low seatbelt gaming activity in which the frequency of the seatbelt gaming activity is greater than the low gaming threshold but less than the high gaming threshold, and a classification of high seatbelt gaming activity in which the frequency of the seatbelt gaming activity is greater than the high gaming threshold.

In various embodiments, the method includes initiating, by the processor, transmission of the record data to a remote computing device.

In various embodiments, the method includes initiating, by the processor, in-vehicle coaching or instruction to the occupant based on the classification attributed to the occupant.

In another embodiment, a system is provided for detection of a seatbelt gaming activity performed by an occupant of a vehicle. The vehicle has a seat for supporting the occupant thereon and a seatbelt configured to secure the occupant to the seat. The system includes: a computer system onboard the vehicle and configured to, by a processor: receive sensor data generated by at least one sensing device of the vehicle, determine the seatbelt gaming activity has occurred based on the sensor data, wherein the seatbelt gaming activity occurs when the seatbelt of the vehicle is latched while the occupant is not secured to the seat with the seatbelt, perform a persistence check to compare a frequency of the seatbelt gaming activity over a period of time to a minimum seatbelt gaming activity threshold, determine a classification of seatbelt gaming activity attributed to the occupant based on the persistence check, and generate record data that includes the classification of seatbelt gaming activity attributed to the occupant.

In various embodiments, the sensor data includes activation data generated by a digital key sensing device, and determining the seatbelt gaming activity has occurred is based on a determination that a digital key remotely started the vehicle and/or remotely locked a door of the vehicle while the seatbelt was latched.

In various embodiments, the sensor data includes position data generated by a range selection device status sensing device configured to sense a position of a range selection device configured to select a range of a transmission of the vehicle, and determining the seatbelt gaming activity has occurred is based on a determination that the vehicle was shifted into park while the seatbelt was latched and the seatbelt remained latched for a time period in excess of a parking threshold and/or an idling threshold.

In various embodiments, the sensor data includes door data generated by a door status sensing device, and determining the seatbelt gaming activity has occurred is based on a determination that a door of the vehicle was opened, closed, and/or locked while the seatbelt was latched and the seatbelt remained latched for a period of time in excess of a door wait threshold or a lock wait threshold.

In various embodiments, the sensor data includes occupancy data generated by a seat occupancy sensing device or a driver monitor system, and determining the seatbelt gaming activity has occurred is based on a determination that the seat was unoccupied while the seatbelt was latched and the seatbelt remained latched for a period of time in excess of an occupancy threshold.

In various embodiments, the sensor data includes occupancy data generated by seat occupancy sensing device or a driver monitor system and seatbelt strap data generated by a seatbelt pretensioner sensing device and/or a seatbelt limiter device, and determining the seatbelt gaming activity has occurred is based on the seat being occupied while the seatbelt was latched and the strap of the seatbelt was not stretched.

In various embodiments, performing the persistence check includes comparing the frequency of the seatbelt gaming activity to a low gaming threshold and a high gaming threshold, wherein determining a classification of the seat belt gaming activity includes a first classification of no seatbelt gaming activity in which the frequency of the gaming activity is less than the low gaming threshold, a classification of low seatbelt gaming activity in which the frequency of the seatbelt gaming activity is greater than the low gaming threshold but less than the high gaming threshold, and a classification of high seatbelt gaming activity in which the frequency of the seatbelt gaming activity is greater than the high gaming threshold.

In various embodiments, the computer system is configured to, by the processor, initiate transmission of the record data to a remote computing device.

In various embodiments, the computer system is configured to, by the processor, initiate in-vehicle coaching or instruction to the occupant based on the classification attributed to the occupant.

In another embodiment, a vehicle includes: a seat for supporting an occupant thereon, a seatbelt configured to secure the occupant to the seat, one or more sensing devices configured to generate sensor data, and a computer system onboard the vehicle and configured to, by a processor: receive sensor data generated by at least one sensing device of the vehicle, determine a seatbelt gaming activity has occurred based on the sensor data, wherein the seatbelt gaming activity occurs when the seatbelt of the vehicle is latched while the occupant is not secured to the seat with the seatbelt, perform a persistence check to compare a frequency of the seatbelt gaming activity over a period of time to a minimum seatbelt gaming activity threshold, determine a classification of seatbelt gaming activity attributed to the occupant based on the persistence check, and generate record data that includes the classification of seatbelt gaming activity attributed to the occupant.

In various embodiments, the vehicle does not include a seat occupancy sensing device, a driver monitor system (DMS), a seatbelt pretensioner sensing device, and a seatbelt limiter sensing device, wherein the sensor data does not include information indicating whether the seat is occupied or whether a strap of the seatbelt is stretched.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle that includes a seatbelt gaming detection system, in accordance with various embodiments;

FIG. 2 is a dataflow diagram illustrating elements of the seatbelt gaming detection system of the vehicle of FIG. 1, in accordance with various embodiments;

FIG. 3 is a flowchart of a process for detecting seatbelt gaming activities as performed by the seatbelt gaming detection system of the vehicle of FIGS. 1 and 2, in accordance with exemplary embodiments;

FIG. 4 is a flowchart of certain exemplary aspects of the process of FIG. 3 as performed by the seatbelt gaming detection system of the vehicle of FIGS. 1 and 2, in accordance with an embodiment, wherein a determination of seatbelt gaming activities is based on seatbelt buckle status data generated by a seatbelt sensing device and activation data generated by a digital key sensing device;

FIG. 5 is a flowchart of certain exemplary aspects of the process of FIG. 3 as performed by the seatbelt gaming detection system of the vehicle of FIGS. 1 and 2, in accordance with an embodiment, wherein a determination of seatbelt gaming activities is based on position data generated by a range selection device status sensing device;

FIG. 6 is a flowchart of certain exemplary aspects of the process of FIG. 3 as performed by the seatbelt gaming detection system of the vehicle of FIGS. 1 and 2, in accordance with an embodiment, wherein a determination of seatbelt gaming activities is based on door data generated by a door status sensing device;

FIG. 7 is a flowchart of certain exemplary aspects of the process of FIG. 3 as performed by the seatbelt gaming detection system of the vehicle of FIGS. 1 and 2, in accordance with an embodiment, wherein a determination of seatbelt gaming activities is based on occupancy data generated by a seat occupancy sensing device;

FIG. 8 is a flowchart of certain exemplary aspects of the process of FIG. 3 as performed by the seatbelt gaming detection system of the vehicle of FIGS. 1 and 2, in accordance with an embodiment, wherein a determination of seatbelt gaming activities is based on occupancy data generated by a driver monitor system and seatbelt strap data generated by a seatbelt pretensioner sensing device and/or a seatbelt limiter sensing device; and

FIG. 9 is a flowchart of certain exemplary aspects of the process of FIG. 3 as performed by the seatbelt gaming detection system of the vehicle of FIGS. 1 and 2, in accordance with an embodiment, wherein classification of the seatbelt gaming activity is determined.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

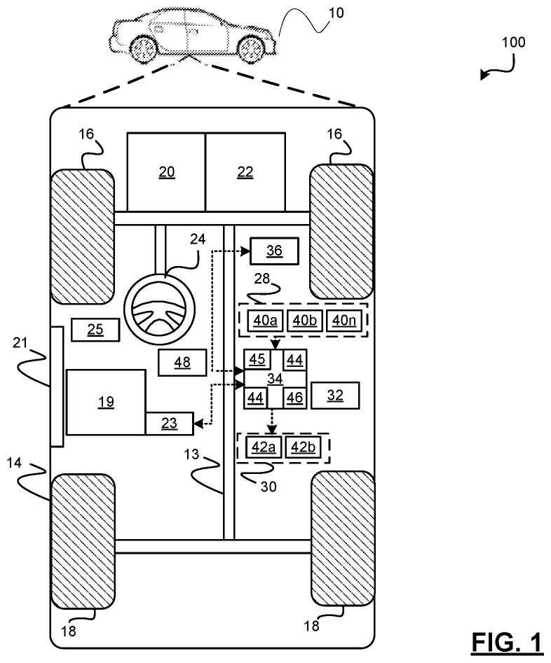

With reference to FIG. 1, a seatbelt gaming detection system shown generally at 100 is associated with a vehicle 10 in accordance with various embodiments. The vehicle may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In various embodiments, the vehicle 10 may also comprise other types of mobile platforms and is not limited to an automobile.

As depicted in FIG. 1, the exemplary vehicle 10 generally includes a chassis 13, a body 14, front wheels 16, and rear wheels 18. The body 14 is arranged on the chassis 13 and substantially encloses components of the vehicle 10. The body 14 and the chassis 13 may jointly form a frame. The wheels 16-18 are each rotationally coupled to the chassis 13 near a respective corner of the body 14. The vehicle 10 further includes at least one door 21 coupled to the body 14 configured to be opened and closed to provide and impede, respectively, access to an interior of the vehicle 10. The vehicle 10 includes at least one seat 19 for supporting an occupant thereon and at least one seatbelt 23 for the seat 19 configured to secure the occupant to the seat 19. For convenience, the seatbelt 23 is described herein as being three-point seatbelts comprising an integral shoulder and lap strap (referred to hereinafter simply as the strap) that may be secured by stretching the strap from a seatbelt retractor, and then coupling a latch of the seatbelt 23 to a seatbelt receiver. However, it should be understood that the vehicle 10 may include more than one seat 19, more than one seatbelt 23, and other types of seatbelts.

The vehicle 10 further includes a propulsion system 20, a transmission system 22, a steering system 24, a range selection device 25 (e.g., gear selector, gear shifter, PRNDL, etc.), a sensor system 28, a communication system 30, at least one data storage device 32, at least one controller 34, a media system 36, and an ignition switch 48. The propulsion system 20 may, in various embodiments, include an internal combustion engine, an electric machine such as a traction motor, and/or a fuel cell propulsion system. The transmission system 22 is configured to transmit power from the propulsion system 20 to the wheels 16-18 according to selectable speed ratios. According to various embodiments, the transmission system 22 may include a step-ratio automatic transmission, a continuously-variable transmission, or other appropriate transmission. The range selection device 25 is configured to select an operating range of the transmission (e.g., gear ratio). The steering system 24 influences a position of the of the wheels 16-18. While depicted as including a steering wheel for illustrative purposes, in some embodiments contemplated within the scope of the present disclosure, the steering system 24 may not include a steering wheel. The ignition switch 48 is configured to be operable to activate and deactivate the propulsion system 20. In some embodiments, the ignition switch 48 may include an “on” position and an “off” position corresponding to activation and deactivation of the propulsion system 20, respectively.

The sensor system 28 includes one or more sensing devices 40a-40n that sense a status or condition of a corresponding component of the vehicle 10 and provide such status to other systems of the vehicle 10, such as the controller 34. The sensing devices 40a-40n may be provided with the vehicle 10 during manufacture thereof that are accessible by the seatbelt gaming detection system 100 or may be after-market components that are subsequently installed for use with the seatbelt gaming detection system 100. It should be understood that the vehicle 10 may include any number of the sensing devices 40a-40n. The sensing devices 40a-40n can include, but are not limited to, a seatbelt sensing device (e.g., a sensing diagnostic module (SDM)) configured to detect whether the seatbelt 23 is latched or unlatched, that is, whether the latch of the seatbelt 23 is coupled to the seatbelt receiver and generate seatbelt buckle status data that includes information related to such detection; an ignition switch sensor configured to detect a position of the ignition switch 48 and/or an operational status of the propulsion system 20, a door status sensing device configured to detect when the door 21 of the vehicle 10 is opened or closed and generate door data that includes information related to such detection; a digital key sensing device configured to detect when a digital key is used to remotely lock or unlock the door 21 of the vehicle 10 or used to remotely initiate ignition of the engine of the vehicle 10 and generate activation data that includes information related to such detection; and a range selection device status sensing device configured to detect a position of a gear shifter of the vehicle 10 and generate position data that includes information related to such detection. In various embodiments, the sensing devices 40a-40n include a seat occupancy sensing device configured to detect whether an occupant is sitting on the seat 19 (e.g., the driver's seat) and generate occupancy data that includes information related to such detection; a driver monitor system (DMS) configured to monitor a driver's alertness and generate occupancy data that includes information related to whether an occupant is sitting on the seat 19; a seatbelt pretensioner sensing device and a seatbelt limiter sensing device configured to, independently or in combination, detect tension or loads on the strap of the seatbelt 23 and generate seatbelt strap data that includes information related to such detection. In various embodiments, the vehicle 10 does not include the seat occupancy sensing device, the driver monitor system (DMS), the seatbelt pretensioner sensing device, and the seatbelt limiter sensing device and is not configured to sense occupancy of the seat 19, monitor the driver, or sense the tension or load on the strap of the seatbelt 23.

In various embodiments, the seatbelt gaming detection system 100 may detect seatbelt gaming activities in certain low-trim vehicles that have a limited availability of sensing devices that may be utilized for such detection. As used herein, the trim of a vehicle refers to a version of a vehicle model that is provided with certain features at the time of manufacture. In general, low-trim vehicles have fewer systems and features relative to high-trim vehicles. For convenience of the following description, low-trim vehicles will be referred to as including the seat belt status sensing device, the door status sensing device, the digital key sensing device, the range selection device status sensing device, and the door status sensing device, but not including the occupancy sensing device, the driver monitor system (DMS), the seatbelt pretensioner sensing device, or the seatbelt limiter sensing device. As such, the low-trim vehicles do not have the capability to detect occupancy of a seat, monitor a driver, or sense tension or load on a strap of a seatbelt corresponding to the seat. Optionally, one or more sensing devices, including but not limited to, the occupancy sensing device, the driver monitor system (DMS), the seatbelt pretensioner sensing device, and/or the seatbelt limiter sensing device may be installed in the low-trim vehicles as after-market components for use with the seatbelt gaming detection system 100. High-trim vehicles will be referred to as including all of the sensing devices included in the low-trim vehicles above as well as the driver monitor system (DMS), the seatbelt pretensioner sensing device, and the seatbelt limiter sensing device.

The communication system 30 is configured to transmit and receive data between various systems of the vehicle 10, such as the seatbelt gaming detection system 100, to computing devices independent, external, and/or remote of the vehicle 10. For example, in various embodiments the communication system 30 includes a physical data port 42a configured to couple with a data cable of, for example, an independent diagnostic tool to exchange data therewith. In various embodiments, the communication system 30 includes a transceiver device 42b configured to wirelessly communicate with a remote database. Such embodiments may enable, for example, an owner of fleet vehicles to monitor occupant compliance with seatbelt use practices, manage occupant education, training, coaching, or instruction regarding proper seatbelt use, etc.

The data storage device 32 stores data for use in controlling the vehicle 10. As can be appreciated, the data storage device 32 may be part of the controller 34, separate from the controller 34, or part of the controller 34 and part of a separate system.

The controller 34 includes at least one processor 44, a communication bus 45, a computer readable storage device or media 46. The processor 44 can be any custom made or commercially available processor, a central processing unit (CPU), a graphics processing unit (GPU), an auxiliary processor among several processors associated with the controller 34, a semiconductor-based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10. The bus 45 serves to transmit programs, data, status and other information or signals between the various components of the vehicle 10. The bus 45 can be any suitable physical or logical means of connecting computer systems and components. This includes, but is not limited to, direct hard-wired connections, fiber optics, infrared, and wireless bus technologies.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically determining occurrences seatbelt gaming activities in the vehicle 10, and generate record data to store classifications of seatbelt gaming activity attributed to specific occupants of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate the record data.

In various embodiments, one or more instructions of the controller 34 are embodied in the seatbelt gaming detection system 100 and, when executed by the processor 44, receive data from the sensor system 28 and process the data in order to monitor seatbelt usage by an occupant of the vehicle 10 including determining whether certain seatbelt gaming activities have occurred in which the occupant attempted to circumvent vehicle safety systems associated with encouraging or requiring use of the seatbelt 23.

As can be appreciated, that the controller 34 may otherwise differ from the embodiment depicted in FIG. 1. For example, the controller 34 may be coupled to or may otherwise utilize one or more remote computer systems and/or other control systems, for example as part of one or more of the above-identified vehicle devices and systems. It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 44) to perform and execute the program. Such a program product may take a variety of forms, and the present disclosure applies equally regardless of the particular type of computer-readable signal bearing media used to carry out the distribution. Examples of signal bearing media include recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 34 may also otherwise differ from the embodiment depicted in FIG. 1, for example in that the computer system of the controller 34 may be coupled to or may otherwise utilize one or more remote computer systems and/or other control systems.

The media system 36 is configured to provide in-vehicle coaching and/or instructions to an occupant of the vehicle 10. In various embodiments, the media system 36 may include a visual display device and/or an audio sound system.

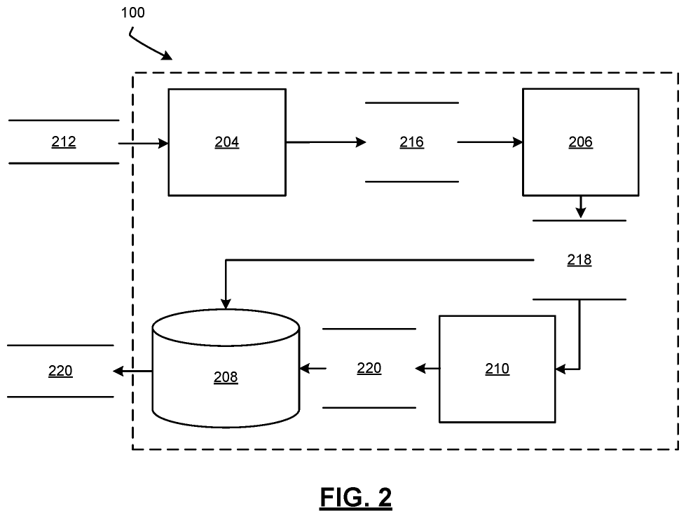

With reference to FIG. 2 and with continued reference to FIG. 1, a dataflow diagram illustrates elements of the seatbelt gaming detection system 100 of FIG. 1 in accordance with various embodiments. As can be appreciated, various embodiments of the seatbelt gaming detection system 100 according to the present disclosure may include any number of modules embedded within the controller 34 which may be combined and/or further partitioned to similarly implement systems and methods described herein. Furthermore, inputs to the seatbelt gaming detection system 100 may be received from the sensor system 28, received from other control modules (not shown) associated with the vehicle 10, and/or determined/modeled by other sub-modules (not shown) within the controller 34 of FIG. 1. Furthermore, the inputs might also be subjected to preprocessing, such as sub-sampling, noise-reduction, normalization, feature-extraction, missing data reduction, and the like. In various embodiments, the seatbelt gaming detection system 100 includes a seatbelt gaming detection module 204, a classification module 206, an occupant record data datastore 208, and an in-vehicle coaching module 210.

In various embodiments, the seatbelt gaming detection module 204 receives as input sensor data 212 generated by the sensor system 28. The sensor data 212 includes various data indicating a condition of the vehicle 10 and/or components thereof such as seatbelt buckle status (e.g., latched or unlatched), door status (e.g., open or closed), range selection device status (e.g., park), seat occupancy status (e.g., occupied or not occupied), seatbelt strap status (e.g., stretched or unstretched), etc.

The seatbelt gaming detection module 204 evaluates/analyzes the sensor data 212 in order to determine whether seatbelt gaming activities have been performed by one of the occupants of the vehicle 10. A determination that the seatbelt gaming activity has occurred is made when the seatbelt 23 of the vehicle 10 is latched while the occupant is not secured to the seat 19 with the seatbelt 23. In various embodiments, the seatbelt gaming activities may include certain activities by the occupant intended to circumvent a seatbelt notification system and/or a seatbelt requirement system of the vehicle 10 during operation of the vehicle 10 such that the seatbelt notification system and/or a seatbelt requirement system incorrectly detects that the occupant is wearing the seatbelt 23 when in fact the occupant is not wearing the seatbelt 23.

In various embodiments, the classification module 206 receives as input seatbelt gaming activity data 216. The seatbelt gaming activity data 216 includes various data indicating that the status or condition of the vehicle 10 and/or components thereof indicate that one of the occupants of the vehicle 10 may have performed the seatbelt gaming activity.

The classification module 206 evaluates/analyzes the seatbelt gaming activity data 216 in order to determine whether the occupant of the vehicle 10 has performed a seatbelt gaming activity by comparing a frequency of the seatbelt gaming activity over a period of time to one or more seatbelt gaming activity thresholds.

In various embodiments, the in-vehicle coaching module 210 receives as input classification data 218. The classification data 218 includes various data indicating a classification of seatbelt gaming activity associated with the occupant of the vehicle 10.

The in-vehicle coaching module 210 evaluates the classification data 218 in order to determine appropriate coaching programs to execute and/or initiate based on the classification of seatbelt gaming activity attributed to the occupant. For example, the coaching programs may include audible and/or visual communications relating to safety and/or policy information intended to educate the occupant of proper seatbelt usage and/or cease seatbelt gaming activities.

In various embodiments, the occupant record data datastore 208 receives as input the classification data 218 and stores information about records of seatbelt gaming activity attributed to various occupants of the vehicle 10. In various embodiments, the occupant record data datastore 208 receives as input coaching data 220 that includes various data indicating coaching and/or instructions provided to various occupants of the vehicle 10 and stores information about the coaching and/or instruction received by the various occupants of the vehicle 10.

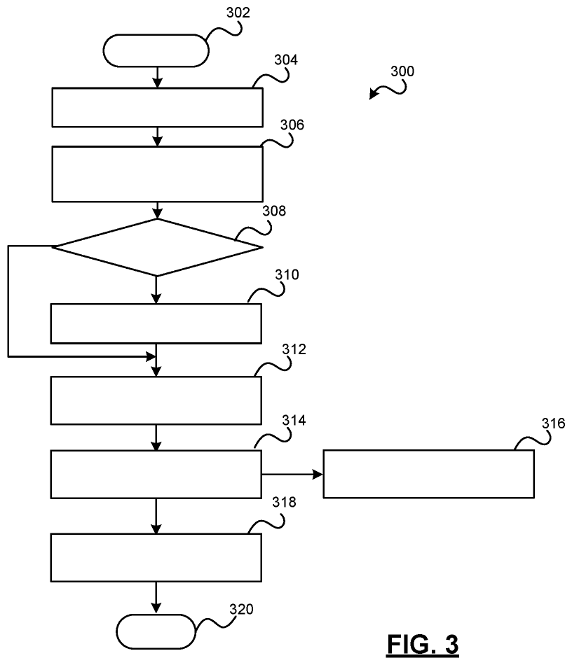

With reference now to FIG. 3 and with continued reference to FIGS. 1-2, a flowchart provides a method 300 for detecting seatbelt gaming activities performed by occupants of the vehicle 10 as performed by the seatbelt gaming detection system 100, in accordance with exemplary embodiments. As can be appreciated in light of the disclosure, the order of operation within the method 300 is not limited to the sequential execution as illustrated in FIG. 3, but may be performed in one or more varying orders as applicable and in accordance with the present disclosure. In various embodiments, the method 300 can be scheduled to run based on one or more predetermined events, and/or can run continuously during operation of the vehicle 10.

In one example, the method 300 may begin at 302. While the vehicle 10 is running (e.g., powered by a battery and/or having an engine thereof operating), the sensor data 212 is received at 304 including information from one or more of the sensing devices 40a-40n relating to a condition or status of the vehicle 10 or a component thereof. The sensor data 212 is evaluated/analyzed at 306 to determine if the seatbelt gaming activity has occurred in the vehicle 10 during operation thereof. When a determination that the seatbelt gaming activity has occurred at 308, a persistence check is performed at 310 to determine a frequency of the seatbelt gaming activity over a period of time. Upon completion of the persistence check, a classification is assigned to the occupant of the vehicle 10 at 312 related to the level of gaming activity performed thereby. At 314, a record of the classification attributed to the occupant based the seatbelt gaming activities performed thereby is stored. Optionally, in-vehicle coaching and/or instruction may be provided to the occupant at 316 based on the classification of gaming activity attributed to the occupant. At 318, the record attributed to the occupant may be transmitted to an independent, external, and/or remote computing device. Therefore, the method may end at 320.

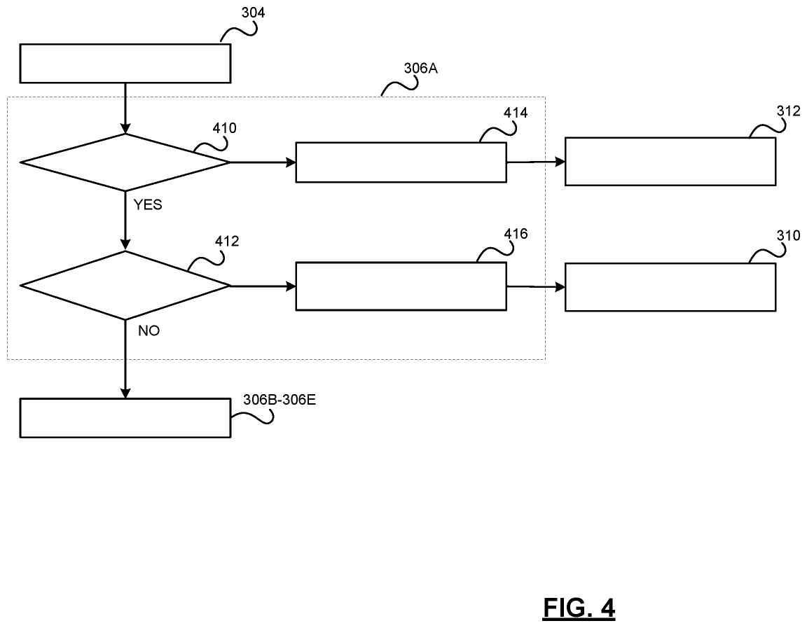

FIGS. 4-8 include flowcharts that represent various nonlimiting specific aspects of 306 of the method 300, that is, determining whether seatbelt gaming activity has occurred based on the sensor data 212. These aspects provide various exemplary conditions that may indicate that the occupant of the vehicle 10 has performed the seatbelt gaming activities.

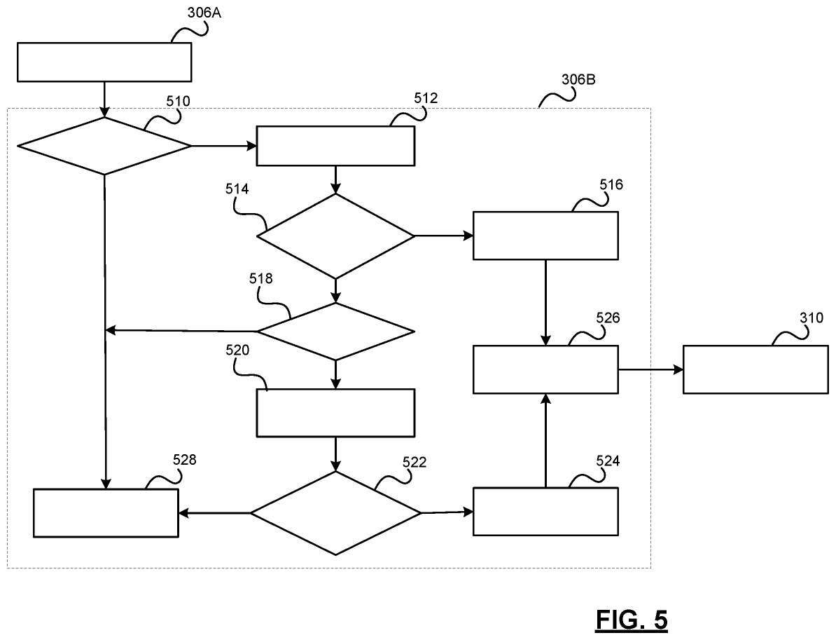

Referring to FIG. 4, the sensor data 212 is evaluated/analyzed in an initial determination process, identified in FIGS. 4-8 as 306A, that includes determining at 410 whether the seatbelt 23 is latched or unlatched. If at any time during the evaluation the seatbelt 23 is detected as unlatched, a determination is made at 414 that the seatbelt gaming activity did not occur. At 412, if a digital key is used to remotely lock or unlock the door 21 or used to remotely start the vehicle 10 at any time while the seatbelt 23 is latched, a determination is made at 416 that the seatbelt gaming activity has occurred. If the seatbelt 23 is latched but there is no detection of an action performed with the digital key, the evaluation continues with aspects represented in FIGS. 5-8 (identified as 308B-308E). Notably, the exemplary aspects of 306 presented in FIG. 4 may be applicable to both low trim and high trim vehicles.

Referring to FIG. 5, a flowchart is provided for detecting seatbelt gaming activities relating to parking and/or multiple stop scenarios. While the vehicle 10 is operating, if the range selection device 25 is shifted into “park” (e.g., moving a gear shifter into a park position) while the seatbelt 23 is latched at 510, a parking timer is started at 512. The parking timer is compared at 514 to a parking threshold that represents a maximum amount of time that the vehicle 10 may be in park with the seatbelt 23 latched before the seatbelt gaming activity has occurred. If the parking timer exceeds the parking threshold, the parking timer may be stopped and reset at 516 and a determination is made at 526 that the seatbelt gaming activity has occurred.

While the vehicle 10 is in park but the parking timer is less than the parking threshold, the status of the ignition switch (e.g., vehicle key) may be monitored at 518 for detecting whether the ignition is switched off. For example, if the ignition switch is switched to the “off” position (or the propulsion system 20 is otherwise deactivated), a determination is made at 518 that it is unknown whether seatbelt gaming activity has occurred. In contrast, if the ignition switch is left in the “on” position (or the propulsion system 20 is otherwise activated), an idling timer is started at 520. The idling timer is compared to an idling threshold at 522 that represents a maximum amount of time that the vehicle 10 may be stopped with the seatbelt 23 latched and the engine running before the seatbelt gaming activity has occurred. If the idling timer exceeds the idling threshold, the idling timer may be stopped and reset at 524 and a determination is made at 526 that the seatbelt gaming activity has occurred. While the parking timer and/or the idling timer are running, a sensing diagnostic module (SDM) of the vehicle 10 may remain active (i.e., awake).

If the range selection device 25 is shifted from park prior to the parking timer and/or the idling timer exceeding the parking threshold and the idling threshold, respectively, a determination is made at 528 that it is unknown whether the seatbelt gaming activity has occurred. If the seatbelt 23 is latched but the digital key has not been used and the range selection device 25 has not been shifted to park, then a determination is made at 528 that it is unknown whether the seatbelt gaming activity has occurred. Notably, the exemplary aspects of 306 presented in FIG. 5 may be applicable to both low trim and high trim vehicles.

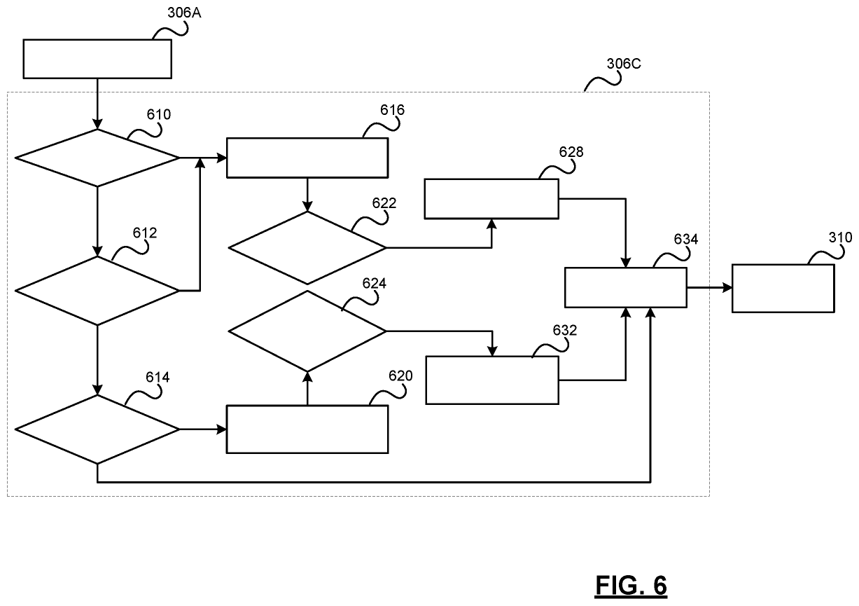

Referring to FIG. 6, a flowchart is provided for detecting seatbelt gaming activities relating to vehicle exit scenarios. While the vehicle 10 is operating and upon coming to a stop (with or without the range selection device 25 being shifted to park), if the door 21 is not opened and the seatbelt is latched at 610, a door wait timer is started at 616. The door wait timer is compared to a door wait threshold at 622 that represents a maximum amount of time that the door 21 may be closed with the seatbelt 23 latched and the vehicle stopped before the seatbelt gaming activity has occurred. If the door wait timer exceeds the door wait threshold, the door wait timer may be stopped and reset at 628 and a determination is made at 634 that the seatbelt gaming activity has occurred.

If the door 21 is opened while the seatbelt 23 is latched at 610 but the door 21 is not subsequently closed at 612, the door wait timer is started at 616 and compared to the door wait threshold at 622. If the door wait timer exceeds the door wait threshold, the door wait timer may be stopped and reset at 228 and a determination is made at 634 that the seatbelt gaming activity has occurred. If the door 21 is subsequently closed at 612 but remains unlocked at 614, a lock wait timer is started at 620. The lock wait timer is compared to a lock wait threshold at 624 that represents a maximum amount of time that the door 21 may be closed and unlocked with the seatbelt 23 latched before the seatbelt gaming activity has occurred. If the lock wait timer exceeds the lock wait threshold, the lock wait timer may be stopped and reset at 632 and a determination is made at 634 that the seatbelt gaming activity has occurred. If the door 21 is subsequently locked at 614 while the seatbelt 23 remains latched, a determination is made at 634 that the seatbelt gaming activity has occurred. While the door wait timer and/or the lock wait timer are running, the sensing diagnostic module (SDM) may remain active (i.e., awake). Notably, the exemplary aspects of 306 presented in FIG. 6 may be applicable to both low trim and high trim vehicles.

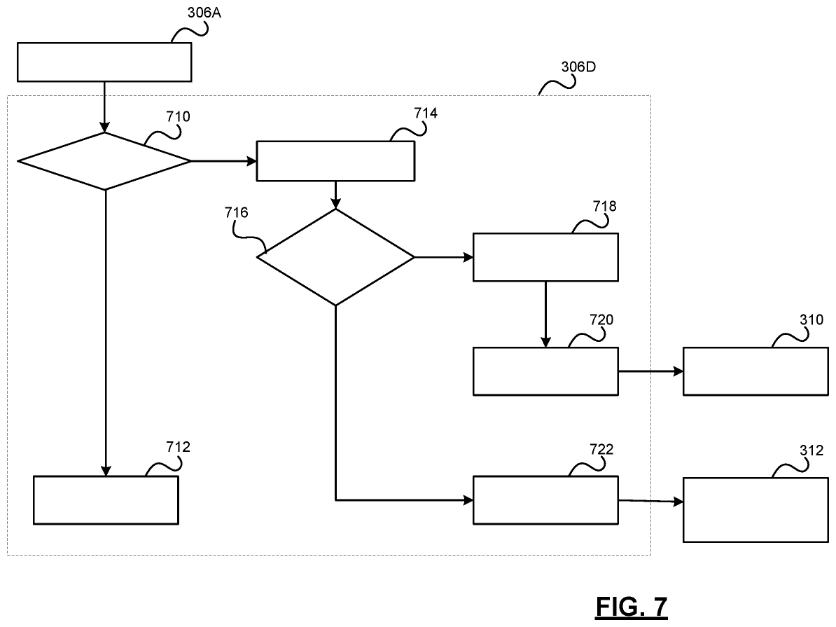

Referring to FIG. 7, a flowchart is provided for detecting seatbelt gaming activities relating to seat occupancy. While the vehicle 10 is operating, if the seatbelt 23 is latched and the seat 19 is occupied at 710, a determine is made at 712 that it is unknown whether the seatbelt gaming activity has occurred. If the seatbelt 23 is latched and the seat 19 is not occupied, an occupancy timer is started at 714. The occupancy timer is compared to an occupancy threshold at 716 that represents a maximum amount of time that the seat 19 may be unoccupied with the seatbelt 23 latched before the seatbelt gaming activity has occurred. If the occupancy timer exceeds the occupancy threshold, the occupancy timer may be stopped and reset at 718 and a determination is made at 720 that the seatbelt gaming activity has occurred. If the seat 19 becomes occupied prior to the occupancy timer exceeding the occupancy threshold, a determination is made at 722 that the seatbelt gaming activity has not occurred. Notably, the exemplary aspects of 306 presented in FIG. 4 may be applicable to both low trim and high trim vehicles, provided such vehicles include the seat occupancy sensing device, the DMS, or both.

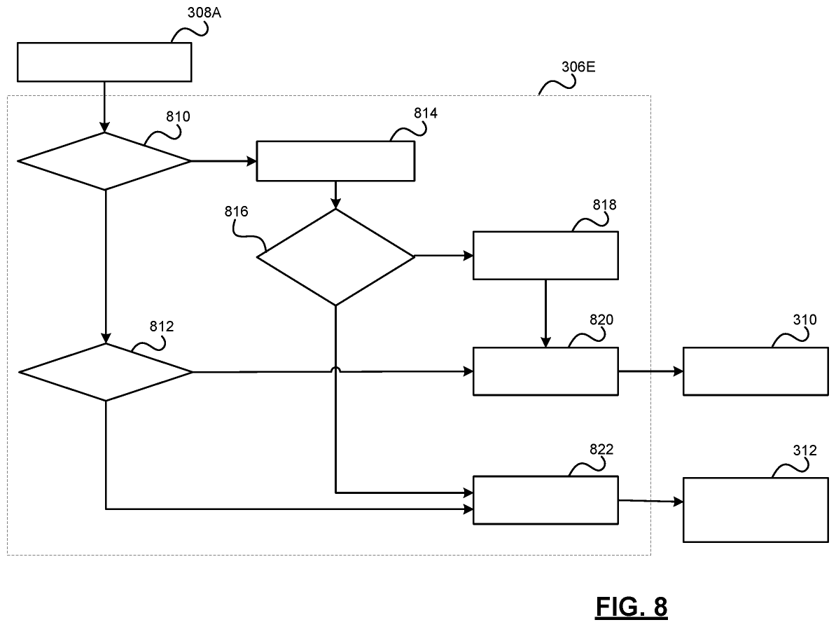

Referring to FIG. 8, a flowchart is provided for detecting seatbelt gaming activities relating to seat occupancy and seatbelt tension. 810, 814, 816, and 818 are substantially the same as described above in reference to 710, 714, 716, and 718, respectively. At 812, the sensor data 212 is evaluated to determine whether the seatbelt 23 is stretched (i.e., extended or unrolled from a seatbelt retractor). If the seatbelt 23 is latched, the seat 19 is occupied, and the seatbelt 23 is stretched (i.e., extended or unrolled from a seatbelt retractor), a determination is made at 822 that the seatbelt gaming activity has not occurred. However, if the seatbelt 23 is latched, the seat 19 is occupied, and the seatbelt 23 is not stretched (i.e., not extended or unrolled from a seatbelt retractor), a determination is made at 820 that the seatbelt gaming activity has occurred. Notably, the exemplary aspects of 306 presented in FIG. 8 may be applicable to high trim vehicles.

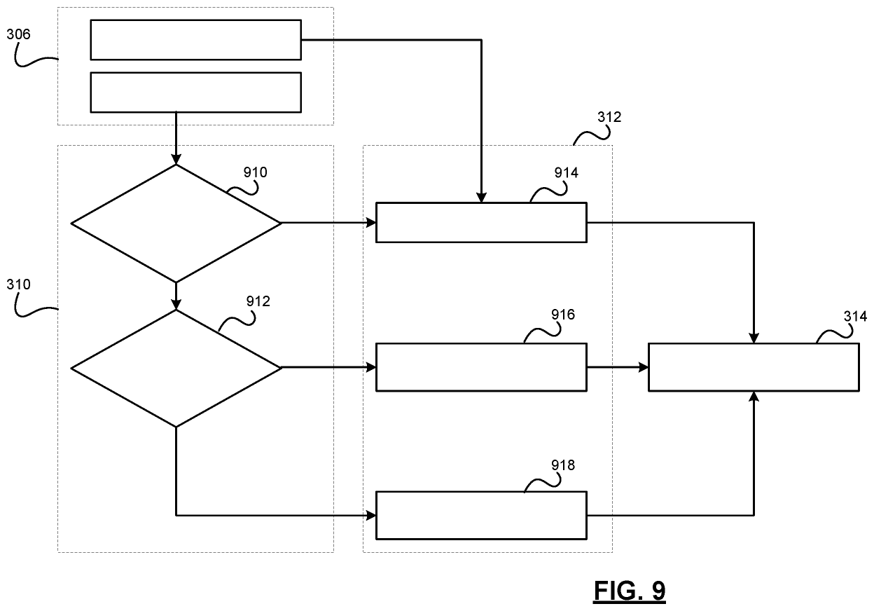

Referring to FIG. 9, if the evaluation of the sensor data 212 results in a determination that the seatbelt gaming activity has occurred, a persistence check is performed to classify the seatbelt gaming activity as attributed to a specific occupant. The persistence check includes a comparison of all recorded seatbelt gaming activities detected within a calibration time window. If the frequency of the seatbelt gaming activity is less than a low gaming threshold at 910, a classification is attributed to the occupant at 914 of “no seatbelt gaming activity.” If the frequency of the seatbelt gaming activity is greater than the low gaming threshold at 910 but less than a high gaming threshold at 912, a classification is attributed to the occupant at 916 of “low seatbelt gaming activity.” If the frequency of the seatbelt gaming activity is greater than the high gaming threshold at 912, a classification is attributed to the occupant of “high seatbelt gaming activity.” It should be understood that the persistence check may include any number of seatbelt gaming activity thresholds corresponding to a corresponding number of classifications of seatbelt gaming activity, and therefore is not limited to the exemplary classifications of low and high gaming activity described herein.

The systems and methods are not limited to any particular type of vehicles, seats, or seatbelts. Further, the system and methods are primarily described in relation to a driver, a driver's seat, a seatbelt associated with (i.e., corresponding to) the driver's seat, a door adjacent to the driver's seat, etc.; however, the systems and methods are applicable to other occupants, seats, seatbelts, doors, etc. of the vehicle 10.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for detection of a seatbelt gaming activity performed by an occupant of a vehicle, the vehicle having a seat for supporting the occupant thereon and a seatbelt configured to secure the occupant to the seat, the method comprising:
receiving, by a processor, sensor data generated by at least one sensing device of the vehicle;
determining, by the processor, the seatbelt gaming activity has occurred based on the sensor data, wherein the seatbelt gaming activity occurs when the seatbelt of the vehicle is latched while the occupant is not secured to the seat with the seatbelt;
performing, by the processor, a persistence check to compare a frequency of the seatbelt gaming activity over a period of time to a minimum seatbelt gaming activity threshold;
determining, by the processor, a classification of seatbelt gaming activity attributed to the occupant based on the persistence check; and
generating, by the processor, record data that includes the classification of seatbelt gaming activity attributed to the occupant.

2. The method of claim 1, wherein the sensor data includes activation data generated by a digital key sensing device, wherein determining the seatbelt gaming activity has occurred is based on a determination that a digital key remotely started the vehicle and/or remotely locked a door of the vehicle while the seatbelt was latched.

3. The method of claim 1, wherein the sensor data includes position data generated by a range sensing device configured to sense a status of a range selection device configured to select a range of a transmission of the vehicle, wherein determining the seatbelt gaming activity has occurred is based on a determination that the range selection device of the vehicle was shifted into park while the seatbelt was latched and the seatbelt remained latched for a time period in excess of a parking threshold and/or an idling threshold.

4. The method of claim 1, wherein the sensor data includes door data generated by a door status sensing device, wherein determining the seatbelt gaming activity has occurred is based on a determination that a door of the vehicle was opened, closed, and/or locked while the seatbelt was latched and the seatbelt remained latched for a period of time in excess of a door wait threshold or a lock wait threshold.

5. The method of claim 1, wherein the sensor data includes occupancy data generated by a seat occupancy sensing device or a driver monitor system, wherein determining the seatbelt gaming activity has occurred is based on a determination that the seat was unoccupied while the seatbelt was latched and the seatbelt remained latched for a period of time in excess of an occupancy threshold.

6. The method of claim 1, wherein the sensor data includes occupancy data generated by seat occupancy sensing device or a driver monitor system and seatbelt strap data generated by a seatbelt pretensioner sensing device and/or a seatbelt limiter sensing device, wherein determining the seatbelt gaming activity has occurred is based on the seat being occupied while the seatbelt was latched and the strap of the seatbelt was not stretched.

7. The method of claim 1, wherein performing the persistence check includes comparing the frequency of the seatbelt gaming activity to a low gaming threshold and a high gaming threshold, wherein determining the classification of the seat belt gaming activity includes a first classification of no seatbelt gaming activity in which the frequency of the seatbelt gaming activity is less than the low gaming threshold, a classification of low seatbelt gaming activity in which the frequency of the seatbelt gaming activity is greater than the low gaming threshold but less than the high gaming threshold, and a classification of high seatbelt gaming activity in which the frequency of the seatbelt gaming activity is greater than the high gaming threshold.

8. The method of claim 1, further comprising initiating, by the processor, transmission of the record data to a remote computing device.

9. The method of claim 1, further comprising initiating, by the processor, in-vehicle coaching or instruction to the occupant based on the classification attributed to the occupant.

10. A system for detection of a seatbelt gaming activity performed by an occupant of a vehicle, the vehicle having a seat for supporting the occupant thereon and a seatbelt configured to secure the occupant to the seat, the system comprising:
a computer system onboard the vehicle and configured to, by a processor:
receive sensor data generated by at least one sensing device of the vehicle;
determine the seatbelt gaming activity has occurred based on the sensor data, wherein the seatbelt gaming activity occurs when the seatbelt of the vehicle is latched while the occupant is not secured to the seat with the seatbelt;
perform a persistence check to compare a frequency of the seatbelt gaming activity over a period of time to a minimum seatbelt gaming activity threshold;
determine a classification of seatbelt gaming activity attributed to the occupant based on the persistence check; and
generate record data that includes the classification of seatbelt gaming activity attributed to the occupant.

11. The system of claim 10, wherein the sensor data includes activation data generated by a digital key sensing device, wherein determining the seatbelt gaming activity has occurred is based on a determination that a digital key remotely started the vehicle and/or remotely locked a door of the vehicle while the seatbelt was latched.

12. The system of claim 10, wherein the sensor data includes position data generated by a range selection device status sensing device configured to sense a status of a range selection device configured to select a range of a transmission of the vehicle, wherein determining the seatbelt gaming activity has occurred is based on a determination that the vehicle was shifted into park while the seatbelt was latched and the seatbelt remained latched for a time period in excess of a parking threshold and/or an idling threshold.

13. The system of claim 10, wherein the sensor data includes door data generated by a door status sensing device, wherein determining the seatbelt gaming activity has occurred is based on a determination that a door of the vehicle was opened, closed, and/or locked while the seatbelt was latched and the seatbelt remained latched for a period of time in excess of a door wait threshold or a lock wait threshold.

14. The system of claim 10, wherein the sensor data includes occupancy data generated by a seat occupancy sensing device or a driver monitor system, wherein determining the seatbelt gaming activity has occurred is based on a determination that the seat was unoccupied while the seatbelt was latched and the seatbelt remained latched for a period of time in excess of an occupancy threshold.

15. The system of claim 10, wherein the sensor data includes occupancy data generated by seat occupancy sensing device or a driver monitor system and seatbelt strap data generated by a seatbelt pretensioner sensing device and/or a seatbelt limiter sensing device, wherein determining the seatbelt gaming activity has occurred is based on the seat being occupied while the seatbelt was latched and the strap of the seatbelt was not stretched.

16. The system of claim 10, wherein performing the persistence check includes comparing the frequency of the seatbelt gaming activity to a low gaming threshold and a high gaming threshold, wherein determining the classification of the seat belt gaming activity includes a first classification of no seatbelt gaming activity in which the frequency of the seatbelt gaming activity is less than the low gaming threshold, a classification of low seatbelt gaming activity in which the frequency of the seatbelt gaming activity is greater than the low gaming threshold but less than the high gaming threshold, and a classification of high seatbelt gaming activity in which the frequency of the seatbelt gaming activity is greater than the high gaming threshold.

17. The system of claim 10, further comprising initiating, by the processor, transmission of the record data to a remote computing device.

18. The system of claim 10, further comprising initiating, by the processor, in-vehicle coaching or instruction to the occupant based on the classification attributed to the occupant.

19. A vehicle, comprising:
a seat for supporting an occupant thereon;
a seatbelt configured to secure the occupant to the seat;
one or more sensing devices configured to generate sensor data;
a computer system onboard the vehicle and configured to, by a processor:
receive the sensor data generated by at least one sensing device of the vehicle;
determine a seatbelt gaming activity has occurred based on the sensor data, wherein the seatbelt gaming activity occurs when the seatbelt of the vehicle is latched while the occupant is not secured to the seat with the seatbelt;
perform a persistence check to compare a frequency of the seatbelt gaming activity over a period of time to a minimum seatbelt gaming activity threshold;
determine a classification of seatbelt gaming activity attributed to the occupant based on the persistence check; and
generate record data that includes the classification of seatbelt gaming activity attributed to the occupant.

20. The vehicle of claim 19, wherein the vehicle does not include a seat occupancy sensing device, a driver monitor system (DMS), a seatbelt pretensioner sensing device, and a seatbelt limiter sensing device, wherein the sensor data does not include information indicating whether the seat is occupied or whether a strap of the seatbelt is stretched.
